(19) United States
(12) Patent Application Publication
(10) Pub. No.: US 2016/0295552 A1
(43) Pub. Date: Oct. 6, 2016

(54) Construction Method for Connecting Information System on Based Beacon

(71) Applicant: Wonchan LEE, Seoul (KR)

(72) Inventor: Wonchan LEE, Seoul (KR)

(21) Appl. No.: 14/813,521

(22) Filed: Jul. 30, 2015

(30) Foreign Application Priority Data
Apr. 6, 2015 (KR) 10-2015-0048679

(51) Int. Cl. H04W 72/00; H04W 16/28

(52) U.S. Cl. CPC H04W 72/005; H04W 16/28

(57) ABSTRACT

The invention relates to A Construction Method for Connecting Information System on Based Beacon comprising: he Access Point 101 and 102 continually Diagram1 Broadcasting a predetermined frequency as a beacon To do this, one broadcasting frequency was accepted by 103 104 user applications are single-user mode is interlocked with 105 single-user mode to the administrator mode information; shown in Administrator mode is set and all transport in the form Sorting in administrator mode, an administrator application position may also be located on the server and not be limited to the user terminal smart devices. This user mode and administrator mode can be collectively managed through a single integrated management system program 111. The exchange of data is usually performed only in administrator mode and 105 number.

### TECHNOLOGY AREAS

The invention of the method for implementing location-based information systems and a variety of different information systems via a connection that we are currently using the invention by using the beacon and the position calculation function of a low-power device technology based on Bluetooth 4.0, Information and Communication Engineering The invention Beacon is a known position as a technology that can combine the low power and location-based services to the basic short-range wireless communication protocol, a Bluetooth-based services system of the ground using GPS, NFC-up has been made by such methods. Beacon has the advantage of being able to provide various services to the user without having to close within this proximity is not limited to the ground with the advantage that there can be up to 75 m using a point that the local area as well as with the non-contact method in fact a few meters.

The present invention is an information system for building such a Bluetooth short-range wireless communications technology and protocol, with the beacon position calculation techniques and location-based information system to an existing information system in a proper way to implement the Internet in the form of objects to connect online and offline The invention relates to a construction methodology.

### BACKGROUND TECHNOLOGY

Technical background of the invention in which the individual uses the frequency band of Bluetooth and the Bluetooth communication has features as to a communication protocol of the portable unit, using the short-range wireless communication through a variety of services based on the beacon with Bluetooth 4.0 receiving a signal to be generated to that of the beacon frequency used to analyze and re-processing operations are required to create the user's application. How to configure this overall location based information system and other information systems in connection in connection to it in some way and apply the invention to a building it does a new location-based information associated with the system. As will be described based on the beacon it is made up of several frame This frame has a standard, and the role standardized protocol.

Role notifies the beacon frame exists (Broadcasting) of the wireless network, performs a search of the wireless network causes (802.11 Scanning) Scanning for the mobile node, as in the beacon, the AP to participate (802.11 bond) to the wireless network to send periodic You can broadcast frames.

Previously, the Bluetooth communication system, each individual mobile station (STA) are most utilized, but it sends a beacon frame in this machine or communication transceiver performance and lack of role earphones listening to music with a simple lack of performance of smart devices in Ad-hoc Mode but now has improved the performance of the frequency transceiver, unlike before, can be performance and infrastructure associated with the smart phone is a lot of different information systems currently power to establish a new type of location-related information systems.

### PRIOR ART DOCUMENT

### Patent Literature

None

### Non-Patent Document

None

### THE CONTENTS OF INVENTION

### To Solve Problems

The invention process material in the frame frequency of the beacon signal generating step to create a server to enhance the accuracy and performance of the location server that it also receives information about the analysis and re-processing of the beacon signal to the user via the application manager made to solve the problem of the invention is to create a method for the server in conjunction with other information to provide it with the system operation to provide service to create a variety of types of location-based information system as a component for each Access Point a put, and the location and the user information provided from the server received the ID of the signal to the other associated servers, the information received by the information system information existing beacon system again. After the logic of the information system to match the individual characteristics the flow of the invention is to create flow.

### Solving Means of the Problem

Solving means of the present invention location-aware low-power technology, utilizing a variety of location-based information technology production systems are provided in conjunction with the other information system that effectively present a variety of information systems commonly used systems, the beacon information with the beacon combined with the aim to create a variety of types of location-based information system. Details of the logic and the process for that key to the invention is simply to configure a variety of location-based information systems associated with the methods and logic, any other information, not only is the system which services are built using the frequency of the Bluetooth communication concepts It has the purpose to describe the technical details. Simply key in various types of information system services invention by Technical Practice saying the way that it implements in conjunction with the other information systems as a model to create a user service using the location information or the sense of Bluetooth communication systems of other information Parameter value and the beacon information system that is a server by matching the invention relates to a method of building a Parameter values of the association information based on a beacon system, the CMS (Contents Management Server) information for an infrastructure that is based on the physical area around the user, or the object is located, by binding to the information associated with the system and the information system for providing in real time as one way to establish a system for comprehensively managing and almost certainly a technical feature for a logic.

### Effects of the Invention

Previously, the present invention is daily and the user or object not provide detailed information on the physical space from the physical constraints in, especially for the case of underground or indoors, the GPS was close to nearly useless, if the NFC It is within 10 cm of a little contact or close proximity almost only to the invention but can send and receive information offline almost all of our location-based services that is everyday life in the museum, exhibition halls, underground shopping malls, department stores, hospitals, taxis, billboards, gas stations, etc. or users in any location object is physically located or can provide information about the total space to move and take advantage of it other existing information systems means that CRM on based beacon, Disaster Evacuation, Access Control System, Asset Management System, Advertising Platform More conjunction can show that the information system has been upgraded a notch service.

The present invention is the redesign of the frame position information to the system and measure the location of the user, and provide it with the location information service for the user and the object passed to other smart devices and uses it and how the frequency and associated with it can provide a greater range of upgraded information system services by combining the functions of the existing information system is provided with various types of information system.

The present invention provides a methodology for configuring a system for providing location-based information via Bluetooth technology to establish in conjunction with the other information systems associated with it, and its detailed construction scheme of each connection method between the beacon information system and other information systems Matching Parameter values to convert the values present in the transformed matching values that can provide services in connection the two information systems key parameter that is to be used as the common concept as a function of the angular position-based information system and other information systems The structure and method for a variety of location-based information systems associated configure the greatest characteristic of the present invention.

### DESCRIPTION OF THE DRAWINGS

FIG. 1 Information System Logic on based beacon

FIG. 2 Information System Detail Logic connected beacon

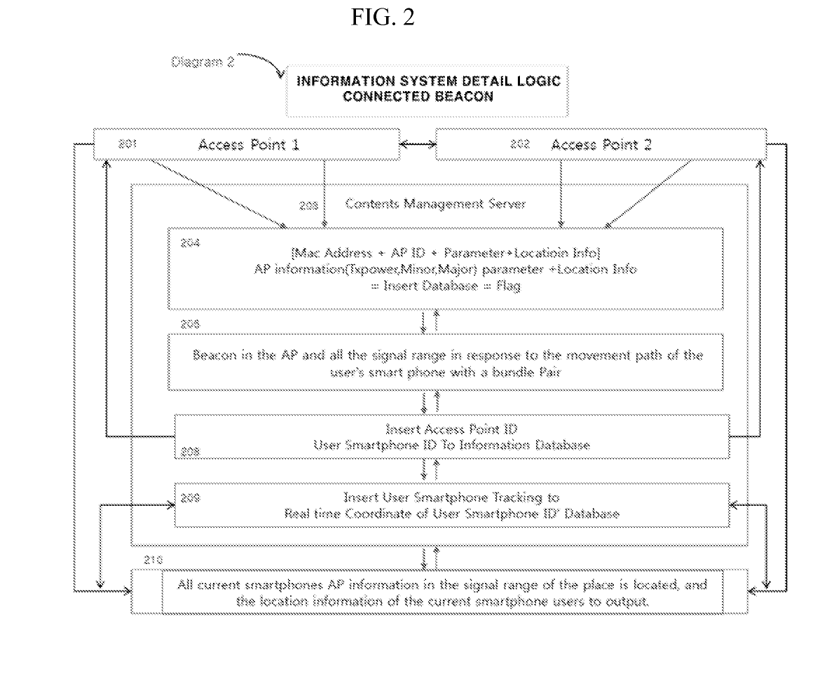

FIG. 3 Customer Relation Management connected beacon

FIG. 4 Advertisement Platform connected beacon

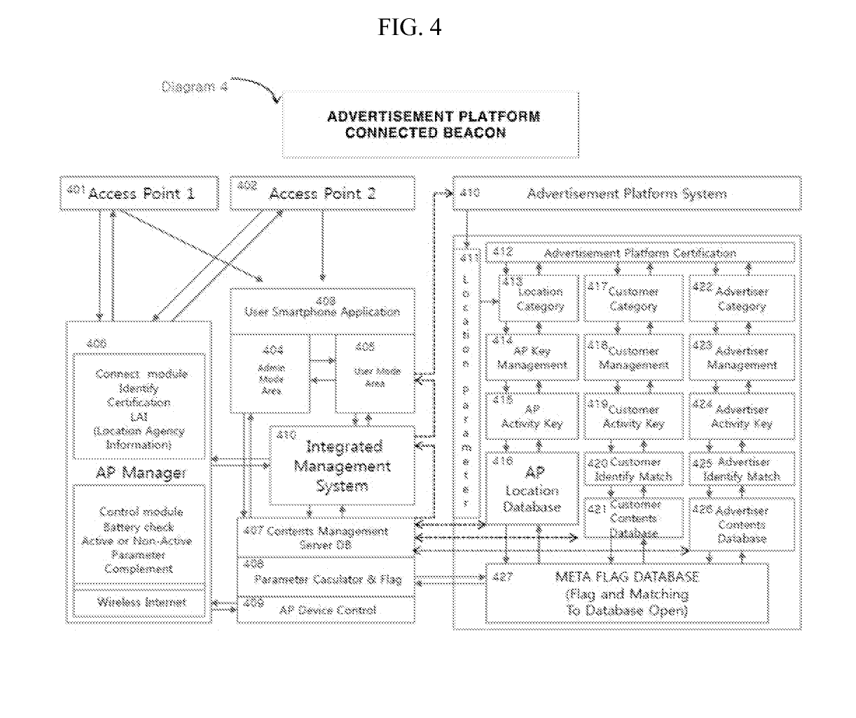

FIG. 5 Disaster Evacuation System on based beacon

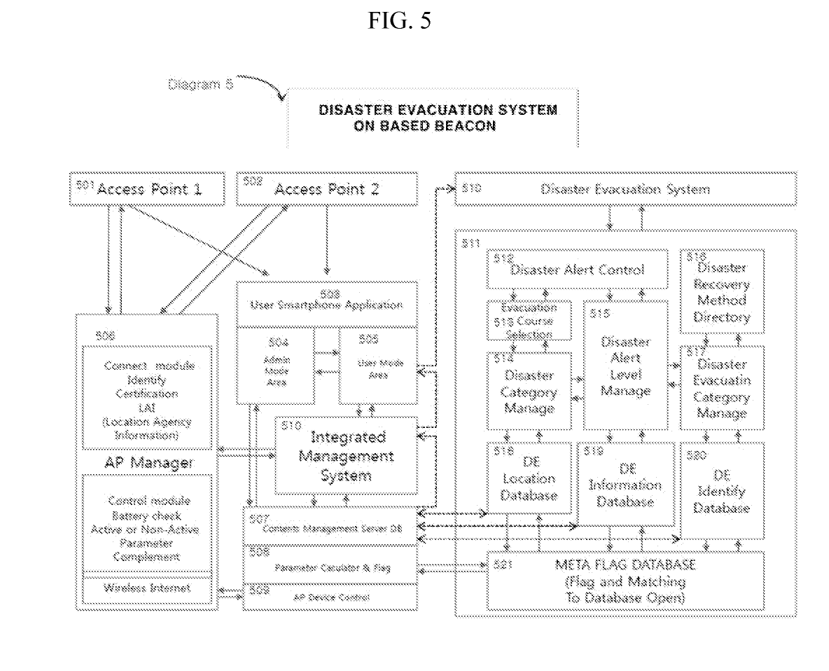

FIG. 6 Access Control connected beacon

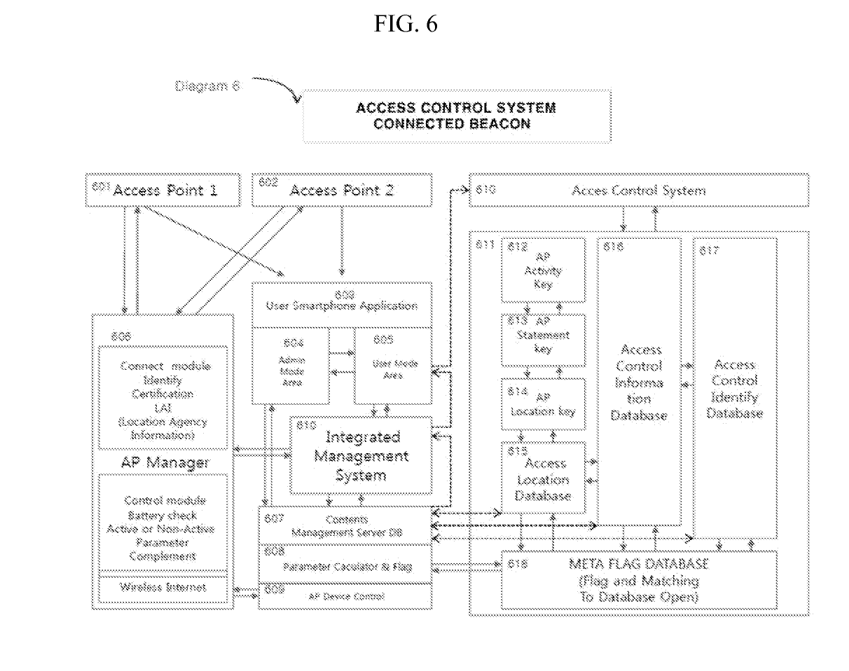

FIG. 7 Asset Management System on based beacon

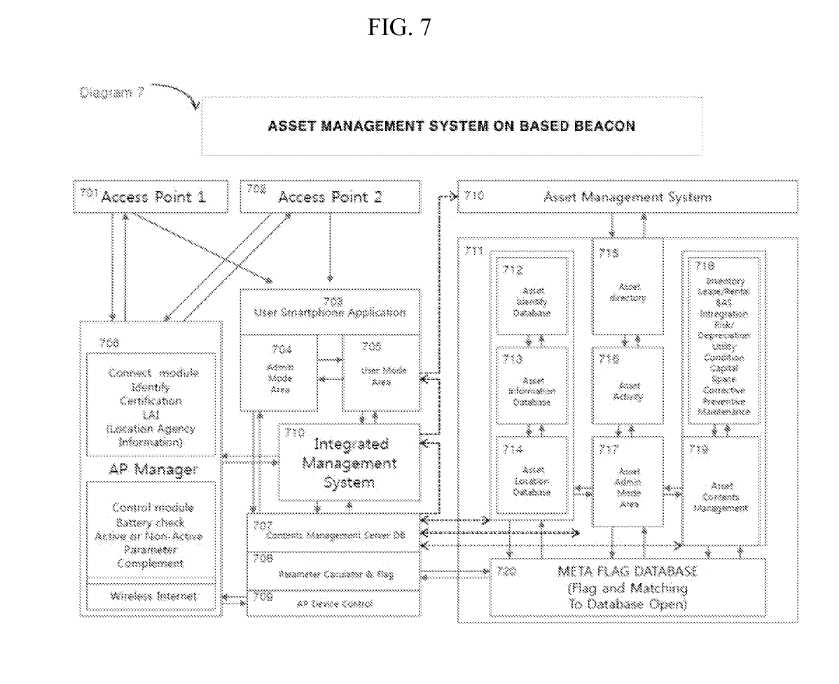

FIG. 8 All Information Management System on based beacon

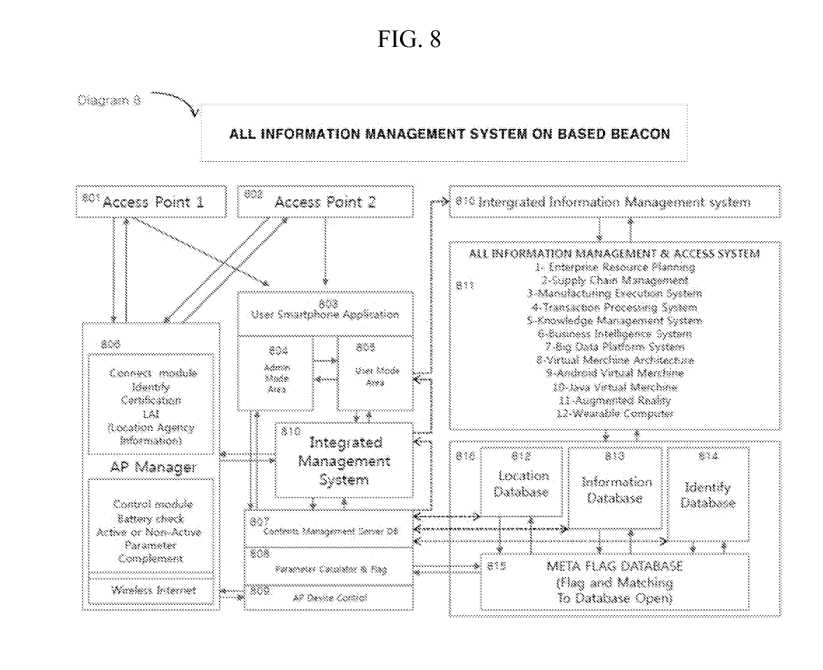

### DETAILED DESCRIPTION OF CARRYING OUT THE INVENTION

The present invention is a user via the user terminal or the smart devices, extracting position information from the frame based on a variety of material and process of the Bluetooth wireless communication protocol, and processing them through a server, and then in conjunction with other information systems based on the invention by Information and Communication Engineering the invention for a method for establishing a location-based information system in conjunction with other information system services.

In more detail to the diagrams for example Diagram1 is also written in the Access Point 101 and 102 configured as described in a beacon-based information system logic it will continue to Broadcasting a predetermined frequency as a beacon. To do this, one broadcasting frequency was accepted by 103 104 user applications in single user mode area is the role that import or show the information directly to the user to indicate the user's User Interface. 104 single-user mode is interlocked with 105 single-user mode to the administrator mode information shown in the administrator mode, and both are sent in the form set by the administrator mode, Sorting, the position of Manager application is not limited only to the smart device user terminal It may also be located on the server.

This user mode and administrator mode can be collectively managed through a single integrated management system program 111. The exchange of data is usually performed only in administrator mode and 105 number. The 111 single integrated management system are brought to view the content in user mode substantially over 108 number Contents Management Server and the data input 108 is controlled via a single CMS 109 with one Parameter Calculator Flag values. AP Device Control 106 and 110 AP Manager1 and AP Manager2 and data input via AP Device other words, 101 number and 102 number the value of the control of the Access Point.

By default, the AP Manager is designed to control the hardware such as the Access Point of a battery, set values, and the signal strength and the period may also be located on a server in the form of software, it can also reside in the near AP to the new hardware.

As described above, one can also receive basic information beacon signals from beacons Broadcasting By describing the logic of the system, the user terminal and thus loaded applications and integrated management administrator and user application programs installed in the server and its integrated management program Contents The AP is configured to be displayed to the user and controlled by Flag and Parameter AP Manager to control and, shows that it works.

Diagram2 is to be described in detail the logic of how to incorporate the information system to receive the signal from the beacon in any way as a view for explaining the detailed logic of a beacon-based information systems.

Access Point1 first 201 number and 202 number the beacon signal received from the Access Point2 process one goes through the process 204 are brought into Contents Management Server through the application of smart device users. That data received from the beacon frequency is by matching with the Mac Address UUID and Parameter value and position information contains The value of the value set of this database has already been set in the existing generating a Flag. The Flag was created by matching each individual user ID and ID values of smart phones such as Access Point 205 number binds to the Fair.

That is, by matching the unique information of position information value, and the user of the AP to generate a Fair code.

Fair code and thus generated is stored in a pre-information on the ID of the current AP you saved a match as 208 number the information of DB User Smartphone ID. That information DB stores the position value to the position of the user value and save it again 209 number the real-time movement path coordinates and Fluctuation of the current user's smart phone to a location DB User Smartphone ID. That is, even if the user position is moved to the position information and be the user's information by the form of the matching key value at the same time variation as the user moves the position AP and AP is changed to change the matching Fair code made for it to be reflected in real time.

In this way all the AP information and the current position information and the user's smart phone signal range where the current in the smart phone 210 is located as one of the type which constitutes a logic output correctly.

Diagram3 echoed merged into a beacon-based customer management information system that provides the user location information function using a beacon simply by drawing the logic for representation as an existing customer management systems and beacon information systems linked to how an integrated information system is a logic diagram showing.

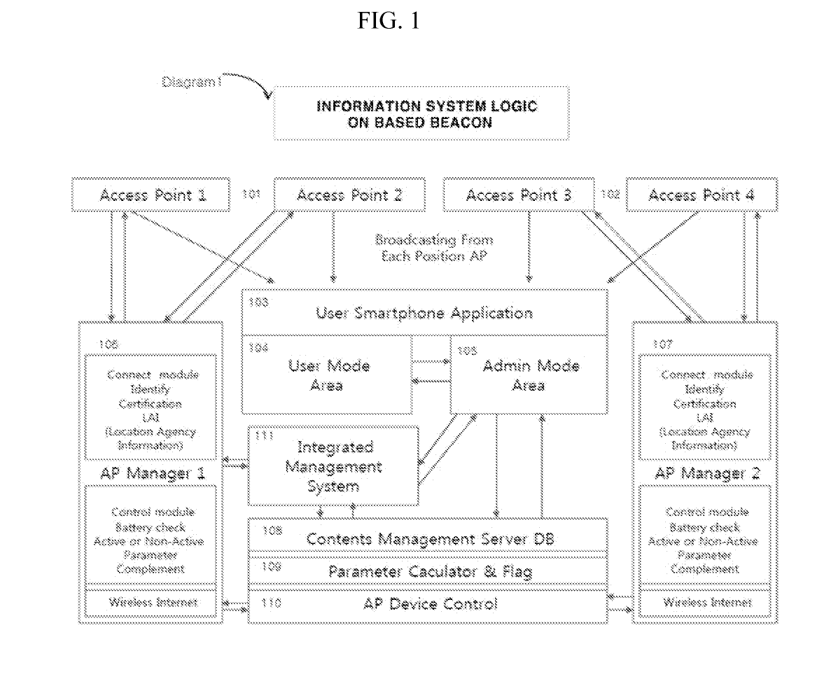

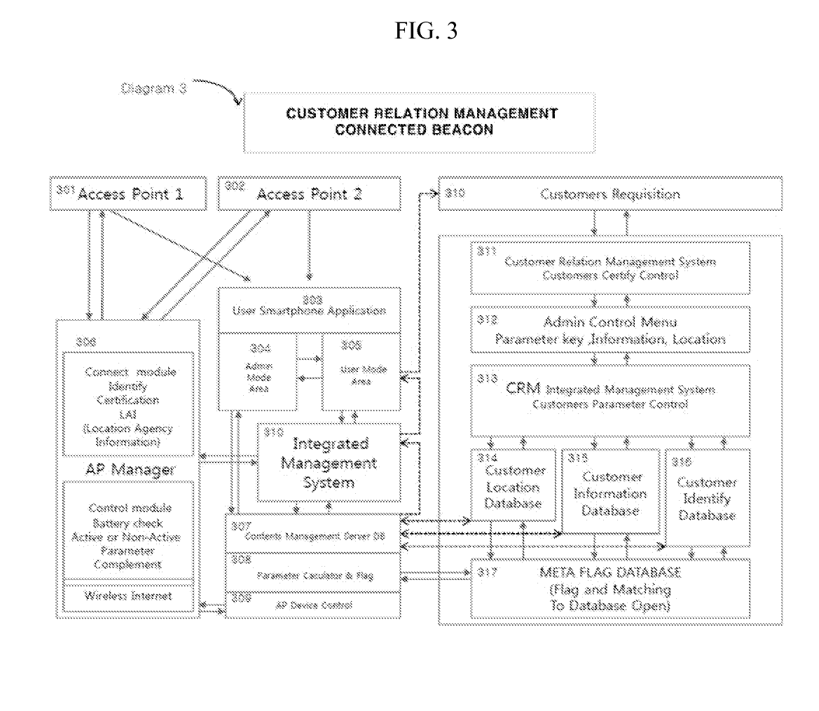

By 301 of FIG. 3 showing the Access Point that is described in FIG. 1 in front of a beacon when the beacon broadcast a signal in each location Smartphone application and user mode mounted thereto a 50 M radius receives 304 it, and the user mode 305 the integrated management of the administrator mode 310, and the search for the CMS DB 307 and shows the creation and the Parameter Flag value as shown in 308 number.

The Parameter Flag values generated with the 308 are used in each of the Part at the customer administrative system from 310 number to 317 number.

Parameter values generated by the first and Flag 308 is once stored in the 317 single Mata Flag Database, is a unique value based on the location of the user or object. This unique value causes the user to request or based on customer management system through the 305 single-user mode, received information and matching. That is, 310 number, as if the user information is received, or received information group is one CRM 311 performs authentication of the customer, the 312 number the Admin Control Menu Parameter key, Information, Location information for each customer, as in 313 Customers The value of each Key Parameter Control through the conversion process performed by Parameter. This Parameter is converted to perform verification at the 314 single Customer location Database, and perform verification at 315 number Customer Information Database, if 316 number to perform verification at the Customer Identify Database Matching to this value by 308 number in 317 matches once approved Send to give the Key value, from 314 number to 316 number Open the database is to make a copy of the content data for the customer information system, customer management system, a beacon to the DB of Contents Management Server. To do this, the copied content is eventually sent to the 304 single-user mode through a single integrated management system 310 and 305 number the administrator mode is shown to the user.

Or more, such as beacon information system and the customer management system and the user application corresponding to the AP information of the request or pre-registered information match with each other, and the current information is located in real time to generate Fair code and the generated beacon Fair code create your own Parameter Parameter is based on the identifier and come as a customer management system and the identifier ID is matched by matching the Flag value generated by the beacon information system server and client management system server at the same time for information Matching If you create a structure that works like the Open the DB.

Diagram4 is a diagram illustrating an advertising platform, the system is connected to the beacon.

Access Point 401 periodically sends out a constant and continual station. 403 number your smart phone applications are received by flipping a frequency 410 number the integrated management systems, integrated management system generates a referral to CMS DB 407 number and 408 number Parameter and Flag, this advertising platform systems up to 427 number from 410 number Matching is used as the value of Flag value. 410 single advertising platform will first be entered in the Location Parameter 411 single module, the position value is selected values from 412 to 415 single Active Key certification system undergoes a single ad platform over 413 single positions Category Access Point Key value management area 414 number, and an update on the Key value is 416 number the active AP Location DB.

Key value to authenticate the user and at the same time, screening the 418 single Customer Management Module con-418 number the active customer value through the activation Key 417 number Customer Category, 420 in matching and verifying whether the customer ID and an update to the 421 single Customer Contents Database The.

In addition, the Key value to authenticate users at the same time, advertisers a single management module 423 via a screened 424 number Advertisers Advertiser Categories enabled Key value and verify whether an advertiser ID and matching 425 number and 426 number to update the content of the advertisers in the DB The.

In other words, location, customer, by matching together the key value for advertisers using key values that match the value of key matches to a common position based on certain specific advertisers' ads to the Flag value to customers and Matching at 427 number its Meta Flag Drag a position to give its customers the advertising value of that particular key advertisers give 407 to 408 number a single ad for it in a database of advertising platforms rough 410 is a single integrated management system, which forms PUSH services to users. Diagram5 the emergency evacuation systems and the relationship between the constant continuously based on the frequency at which the user and the emergency evacuation system broadcast, where the beacon represented by 501 number and 502 number as a view for explaining the logic of the emergency evacuation system is installed in a beacon-based input, modification, deletion of the logic indicates the burning process. 501 number and 502 number the beacon signal received via the AP ID value over 503 single smart phone application and other parameters ultimately passes into 510 single emergency evacuation systems. Emergency evacuation system of logic is one disaster left 512 As described in the notification management system 511 number, 513 number the maximum front-end undergoing emergency evacuation routes that under Module con-selection, undergoes a 514 single type of disaster management module, it is 518 number as disaster evacuation location database It is updated. In addition, 515 refer to the management module for the emergency evacuation level 512 should perform the update in the 519 single emergency evacuation information database. How to list all logic disaster evacuation is performed 516 number in parallel is possible type of disaster management in accordance with the type of disaster (fire, collapse, flooding, training, etc.), it is 520 to 517 number over one disaster evacuation list management module The update is a disaster evacuation ID data base.

So the logic of the disaster evacuation system is carried out in parallel to ensure accuracy in the final stage 521 number Meta Flag databases through a key match between the actual value and if a disaster emergency evacuation system in the field and the actual disaster the actual ratings When the beacon information that is sent to the user system, the service is in user mode.

This means that users usually have a disaster evacuation system has a wealth of information when using only a beacon of information systems from 501 number to 509 number the basic state receives through the existing CMS is if a disaster occurs automatically from 510 number to 521 number is linked with disaster evacuation alerts based on the location of the current user, disaster evacuation routes, disaster types, etc. are stored in conjunction with the database from 518 number to 520 number, is the type used in emergency evacuation systems.

Diagram6 is received from a beacon frequency by 601 number, and 602 shows the logic of a beacon-based access control system 603 that is a single user ID value of the frequency of the smart phone 604 via the single-user mode application is location information to the user The terminal is a location-based information and services.

Bluetooth signal is received from a user application to look up the ID values in 607 of the 610 Contents Management Server through a single integrated management system, is viewed with Flag Parameter values are converted to the value at 608 618 Meta Flag Database and it is to be linked.

In other words, the signal generated by 601 number and 602 number out program installed on the door when the module is to be enabled on your smart phone applications are granted a Notice to single out management system 610 through 611. This is one application smart phone users access control system It is meant to start work with.

In other words, 612 number in a Key value to be generated if activated, the AP Activity Key AP Status Key value at 613 number, 614 number, call the Key value and this location makes updating the 615 single Access Location Database. If your application at the same time in parallel with the access control system is activated and ready to interlock condition, and an update to the 616 single Access Control Information Database, is an update to the 617 single Access Control Identify Database. Key values are separated so that the user updated 618 number in Meta Flag Database Matching and Flag key value to unauthorized users, whether authorized users Open the DB interlocking matches and, in the case of an authorized user to update the 608 single parameter value and Flag and the DB is one of the 607 CMS Approval Notice donor sent out to users through a single integrated management system 610. The one that is 618 Meta Flag Database Update is to perform bi-directional logic, the Flag is updated with 615 number 608 number, 616 number, and also perform the update as one of the 617 Database data.

Therefore, no matter the user is allowed access no matter twice three number all access records management system is allowed to log side always.

Diagram7 an overall diagram showing the logic of the beacon-based Asset Management system

The frequency is received from the input 701 number and 702 number, perform, modify, delete on the management point between asset position and asset management systems through the application of 703 users.

The frequency received by 703 to 707 is to perform a search of the CMS server and user applications received including the identification ID values are undergoing the approval of 704 single administrator mode management module 710 subjected to one integrated management system for AP It is. AP value of search is performed is to create a single 708 Parameter and Flag, when you match it 720 number in conjunction with Meta Flag Database and the Open Database on the existing asset management systems, 710 data through a single integrated management system It is presented to the user in the form.

The 710 single asset management system I have a list of assets in the top-level module, this module are delimited list of assets 715 number their assets destroyed whether the asset is currently available through 716 number, 717 number over the asset management administrator mode 712 number asset ID, 713 number, asset information, the database gets the value of the position is to manage assets of 714 number. In addition, asset management systems can be a form where you can manage your time by managing tangible and intangible assets, as these items are applicable to intangible assets, as well as 718 number. Intangible assets are also managed entry listing all the items, such as rent and purchase, loss, taxes, state loans, space, and maintenance. So items in the asset management system are calculated exists as a single asset item management module 719, 717 number the total assets managed by asset management systems, and access administrator mode, this key value of each item are as Flag over 720 number Meta Flag Database Matching and matches to the Open Database has a structure associated with beacon information system.

That is, when a particular location beacons to the AP's position when you release the left or move its position on asset management means that asset-based assets as well as the words were in that position in the existing, current asset management system is an intangible asset with which will be managed through.

Beacon-based asset management system described in the present invention is basically based on the location of the property, plant and equipment in addition to the asset management system that can manage, even in the form of intangible assets.

Diagram8 was previously described by the drawings describing the logic of the information system linking all the beacon-based method CRM on based beacon, Disaster Evacuation, Access Control System, Asset Management System, Advertising Platform The invention relates to a method to build a new information systems in connection with any other information system.

801 number and 802 number the Access Point are to continue to broadcast the frequency of the beacon frequency signal is in the form of recognition from your smart device through 803 single-user applications, this type of user in the form specified in Administrator mode, single-mode 804 at 805, and the interpretation, the frequency information of the user recognition mode is to search the DB 807 of the Contents Management Server through an integrated management system in 810 single beacon information systems. 807, where the CMS is to perform screening through a single user application 804 in conjunction with the administrator mode, and this is linked as 808 Parameter Flag generation module and a Key value is generated.

That is, the single integrated management system 810 collects the device information managed by the AP to communicate with the hardware as shown in 806 number, and to integrate it to generate the Key value of 808. 806 single hardware management module AP Manager creates a LAI value to perform position correction role for each AP, and also through the battery, and the active and inactive after performing the correction, it 810 number, and the Parameter Management System interworking

The output will be 808 number the value of key. So the key value that is generated form that are linked to work with an integrated information system, such as 811 number and 810 number the 8 ERP, SCM, MES, EPS, KMS, BI, Big Data, Virtual Machine, Android, JAVA Virtual Machine, Augmented Reality, Wearable Computer etc. are all been linked with the Information Technology System and Device.

Again, describing the structure being linked beacon information system parameter values been output by 808 number and 815 number when flag value Meta Flag Database Matching and consistent with the value of the Flag Key works Open the Database of all information systems which usually just Open inconsistencies in the database are property of the type that are connected, non-continuous properties, the most obvious form of integrated information systems can also help to reflect all of the variable properties provided by matching the correct location and informed him fit to write security and data integrity plane can say.

More detailed properties of the data when disagreement of the unique Database for each value of the information system to exchange data with other information systems associated therewith of the beacon generated by the information system and Parameter Flag value to generate a single Fair code, disjoint property, inventions by region to build 816 single database so that all can adequately reflect the variable information is basically 812 number and 813 number the user location information database or object to the information database and the database 814 single ID for each user or object It is organically combined with each other to operate in conjunction with the beacon information system. In conclusion, the present invention is the smart device receives the Bluetooth frequency and process the received value of the material of the frame frequency and to convert it into a Meta Key value generation Fair code value and information system and other information systems of the other beacon information system If the communications infrastructure can be provided in the application it is just as invention relates to a method for building a more upgraded beacon-based integrated information system with basic module in conjunction is a basic user ground or underground somewhere in the cloud-based application without installing It may be utilized as a service. That is, the conventional mobile communication service based on the communication service is provided only Just as a beacon to the base station over the role of the CMS server through the automatic connection to the server in the cloud, if there is installed a particular point and also information associated cloud-based systems It may completely escape even if that offer is to install a physical equipment or space-constrained applications and limitations.

That is, it is not necessary The present invention is also user-installed applications and servers without the need to build and can build beacon information system, it eliminates the need to establish connection based on the information system, database, also to build All that is needed is both a return to a cloud-based service locations and information can also be integrated without integrated information system building cloud back.

The present invention as described above is basically the invention of the contact information system by the simple construction of the beacon, based on how the information system based on various information, and a beacon system as CRM on based beacon, Disaster Evacuation, Access Control System, Asset Management System, Advertising Platform Beacon-based invention relates to a method for linking information systems linked invention is in the form of a cloud, cloud-based information system in this way that the physical constraints of the equipment or space and the Internet in the form of a variety of things, no fully extended when combined linking.

### Example

The actual application must implement to apps or PC software for smart phones

### INDUSTRIAL APPLICABILITY

With both the smart phone and tablet PC in the general network and can also be used with existing information systems linked

### REFERENCE NUMERALS

AP=Access Point

### ([Accession No.])

If you want to organize separately listed on the accession number of microbes that are listed in the description

### ([Sequence Listing Free Text])

Repeat as necessary to base the free text appearing in the Sequence Listing attached to the specification

1. A construction method for connecting information system on based beacon comprising: he Access Point 101 and 102 continually Diagram1 Broadcasting a predetermined frequency as a beacon To do this, one broadcasting frequency was accepted by 103 104 user applications are single-user mode is interlocked with 105 single-user mode to the administrator mode information; shown in Administrator mode is set and all transport in the form Sorting in administrator mode, an administrator application position may also be located on the server and not be limited to the user terminal smart devices.

2. A construction method for connecting information system on based beacon comprising: Access Point1 201 number and 202 number the beacon signal is received from the Access Point2 of Diagram2 are led into Contents Management Server user through the application of smart devices are subjected to the process where the process 204 number; data received from the beacon frequency of the UUID and Parameter value and Mac Address and value there which contains the location information by matching with the value set in the already existing database to create a set Flag; and The Flag was created by matching each individual user ID and ID values of smart phones such as Access Point 205 number binds to the Fair.

3. A construction method for connecting information system on based beacon comprising: beacon broadcasts a signal of Diagram3 smart phone user mode applications and it's equipped with 50 M˜70 M radius receives it and the administrator mode and user mode 310 of the integrated management system 305 of 304 Search for CMS DB 307 and 308 number as shown to generate a Parameter with Flag value.

4. The construction method for connecting information system on based beacon according to claim 1, further comprising Access Point 401 periodically sends out a constant and continual station.

5. The construction method for connecting information system on based beacon according to claim 1, further comprising 501 number and 502 number the beacon signal received via the AP ID value over 503 single smart phone application and other parameters ultimately passes into 510 single emergency evacuation systems

6. The construction method for connecting information system on based beacon according to claim 2, further comprising Diagram6 is received from a beacon frequency by 601 number, and 602 shows the logic of a beacon-based access control system 603 that is a single user ID value of the frequency of the smart phone 604 via the single-user mode application is location information to the user The terminal is a location-based information and services.

7. The construction method for connecting information system on based beacon according to claim 2, further comprising The frequency received from 701 number and 702 number the Diagram7 performs input, modification and deletion of the management point between asset position and asset management systems through the application of 703 users.

8. The construction method for connecting information system on based beacon according to claim 3, further comprising Single integrated management system 810 collects the device information managed by the AP to communicate with the hardware as shown in 806 number, and to integrate it to generate the Key value of 808. 806 single hardware management module AP Manager creates a LAI value to perform position correction role for each AP, and also through the battery, and the active and inactive after performing the correction, it 810 number, and the Parameter Management System interworking.

9. The construction method for connecting information system on based beacon according to claim 3, further comprising If this feature is provided by the communication infrastructure for applications only available in the basic module That is, if the role can only pass the ID of the user beacon signal frequency to the server ground or underground anywhere without having to install the basic position in the cloud-based applications It may be utilized as a service.
